(19) United States
(12) Patent Application Publication
(10) Pub. No.: US 2025/0304778 A1
(43) Pub. Date: Oct. 2, 2025

(54) POST-REACTOR BLENDS OF LINEAR LOW-DENSITY POLYETHYLENES

(71) Applicant: Univation Technologies, LLC, Houston, TX (US)

(72) Inventors: Bo Liu, Pearland, TX (US); Feng Chen, Shanghai (CN); Rongjuan Cong, Lake Jackson, TX (US); Wesley R. Mariott, Manvel, TX (US); Jesse C. Beilhart, South Charleston, WV (US)

(21) Appl. No.: 18/866,647

(22) PCT Filed: Jun. 20, 2023
(86) PCT No.: PCT/US2023/025690

§ 371 Date: Nov. 18, 2024

(30) Foreign Application Priority Data
Jun. 27, 2022 (WO) PCT/CN2022/101400

(51) Int. Cl. C08L 23/0807; B32B 27/08; B32B 27/32; C08J 3/00; C08J 5/18

(52) U.S. Cl. CPC C08L 23/0815; B32B 27/08; B32B 27/327; C08J 3/005; C08J 5/18; B32B 2250/05; B32B 2270/00; C08J 2323/08; C08J 2423/08; C08L 2203/16; C08L 2205/025; C08L 2207/066; C08L 2314/02; C08L 2314/06

(57) ABSTRACT

A post-reactor blend of linear low-density polyethylene copolymers (“LLDPE blend”) comprising a linear low-density ethylene/1-butene copolymer made by copolymerizing ethylene and 1-butene using a spray-dried, ethanol-modified Ziegler-Natta N catalyst and a linear low-density ethylene/1-hexene copolymer made by copolymerizing ethylene and 1-hexene using a bridged bis(indenyl)zirconocene catalyst. A film comprising the LLDPE blend. A method of making the LLDPE blend. A method of making the film.

### FIELD

Polyethylenes, plastic films, polymerization processes, and methods.

### INTRODUCTION

Patent application publications and patents in or about the field include U.S. Pat. Nos. 5,756,193; 9,273,170 B2; 9,394,393 B2; 9,447,265 B2; 9,605,100 B2; 9,714,305 B2; 11,248,066 B2; US 2017/0233507 A1; US 2018/0079836 A1; US 2022/0025135 A1; WO 2009/040139 A1; WO 2019/112929 A1; WO 2020/102385 A1; WO 2020/223191 A1; and WO2021/026134 A1.

### SUMMARY

Embodiments of the present invention include:

A post-reactor blend of linear low-density polyethylene copolymers (“LLDPE blend”) comprising a linear low-density ethylene/1-butene copolymer (“C4-LLDPE”), made by copolymerizing ethylene and 1-butene using a spray-dried, ethanol-modified Ziegler-Natta catalyst (“sdEtOH/ZN”), and a linear low-density ethylene/1-hexene copolymer (“C6-LLDPE”), made by copolymerizing ethylene and 1-hexene using a bridged bis(indenyl)zirconocene catalyst.

A post-reactor method of making the above-described LLDPE blend, the method comprising: melting solids of the C4-LLDPE to form a melt thereof; melting solids of the C6-LLDPE to form a melt thereof; and mixing the melts together to form the LLDPE blend.

A method of making a film comprising the above-described LLDPE blend.

A film comprising the above-described LLDPE blend.

### BRIEF DESCRIPTION OF THE DRAWINGS

FIG. 1 is a schematic cross-sectional view of a multilayer film structure comprising three film layers.

FIG. 2 is a schematic cross-sectional view of a multilayer film structure comprising seven film layers.

### DETAILED DESCRIPTION

Activator (for Ziegler-Natta procatalyst): a trialkylaluminum compound, a dialkylaluminum chloride compound, a dialkylaluminum alkoxide compound, an alkylaluminum dichloride compound, or a combination of any two or more thereof. Examples are triethylaluminum (TEA), triisobutylaluminum (TIBA), tri(n-hexyl)aluminum (TnHAl), diethylaluminum chloride (DEAC), diethylaluminum ethoxide (DEAE), ethylaluminum dichloride (EADC), or a combination of any two or more thereof. E.g., a combination of EADC and TEA. The molar ratio of activator's aluminum to the Ziegler-Natta procatalyst's titanium (Al/Ti molar ratio) may be 1000:1 to 0.5:1, alternatively 300:1 to 1:1, alternatively 150:1 to 1:1.

Activator (for metallocene procatalysts): a Lewis acid, a non-coordinating ionic activator, or an ionizing activator, or a Lewis base, an alkylaluminum, or an alkylaluminoxane (alkylalumoxane). The activator may be methylaluminoxane (MAO), ethylaluminoxane, 2-methylpropyl-aluminoxane, or a modified methylaluminoxane (MMAO). The molar ratio of activator's aluminum to the bridged bis(indenyl)zirconocene procatalyst's zirconium (Al/Zr molar ratio) may be 1000:1 to 0.5:1, alternatively 300:1 to 1:1, alternatively 150:1 to 1:1.

The term “bridged bis(indenyl)zirconocene” means a bidentate ligand-metal complex wherein the metal is Zr and the bidentate ligand comprises two derivatives of indene bonded together via a divalent bridging group. The two derivatives of indene may be independently selected from: unsubstituted indenyl anion, a substituted indenyl anion, unsubstituted tetrahydroindenyl anion, and a substituted tetrahydroindenyl anion. The substituents on the substituted indenyl or substituted tetrahydroindenyl may be alkyl, aryl, or arylalkyl. As used herein “tetrahydroindenyl” means 4,5,6,7-tetrahydroindenyl and a bridged tetrahydroindenyl means a 4,5,6,7-tetrahydro-1-indenyl.

1-Butene or “C4” or “C₄”: a compound of formula H₂C═CHCH₂CH₃.

Ethylene or “C2” or “C₂”: a compound of formula H₂C═CH₂.

Film: a continuous layer of polymeric material having a thickness of from greater than 0 micrometer (μm) to 250 μm, as defined in ASTM Terminology D883. Film thickness is measured according to ASTM D6988-21, Standard Guide for Determination of Thickness of Plastic Film Test Specimens.

1-Hexene or “C6” or “C₆”: a compound of formula H₂C═CHCH₂CH₂CH₂CH₃.

Ethanol or “EtOH”: a compound of formula CH₃CH₂OH.

In-reactor: occurring during a polymerization process and at a location inside a polymerization reactor.

In-reactor blend: a mixture that is made in a polymerization reactor by making a second polymer in the presence of a first polymer in-situ in the polymerization reactor, and wherein either the first polymer is made before the second polymer is made or the first and second polymers are made together simultaneously.

LLDPE: linear low-density polyethylene.

Modifier compound: an acyclic or cyclic oxahydrocarbon consisting of carbon, hydrogen, and oxygen atoms.

Post-reactor: occurring after completion of a polymerization process and at a location outside a polymerization reactor, i.e., not involving an in-reactor process or blend.

Post-reactor blend: a mixture that is made outside of a polymerization reactor by separately making a first polymer and a second polymer apart from each other, and then mixing the first and second polymers together in a mixing device after the making steps are done. The mixing device may be a mixer or melt extruder. At least the second polymer of a post-reactor blend is different in chemical composition and properties from those of a second polymer of an in-reactor blend by virtue of the differences in conditions under which the second polymers are made. When the first and second polymers are made together simultaneously, the first polymer of the post-reactor blend is also different in chemical composition and properties from those of the first polymer of the in-reactor blend by virtue of the differences in conditions under which the first polymers are made.

Procatalyst: a catalyst precursor that when contacted with an activator makes a catalyst.

Tetrahydrofuran or “THF”: a monocyclic ether of formula C₄H₈O.

Ziegler-Natta catalyst: generally is a titanium catalyst supported on magnesium dichloride solids, and, optionally, a silica. The catalyst is made by contacting a Ziegler-Natta procatalyst with the activator described above. The typical Ziegler-Natta (pro)catalyst comprises a titanium(IV) compound (e.g., Ti(O-isopropyl)₄ or TiCl₄) supported on magnesium halide (e.g., MgCl₂) solids and, optionally, a hydrophobic fumed silica (e.g., Cab-O-Sil TS-610). The procatalyst may be unmodified, i.e., free of a modifier compound or the Ziegler-Natta (pro)catalyst may be modified by a modifier compound. The modifier compound may be an unsubstituted ether, an unsubstituted alcohol, or a combination thereof; e.g., tetrahydrofuran, ethanol, or a combination of tetrahydrofuran (“THF”) and ethanol (“EtOH”).

Zirconium means zirconium(IV) unless otherwise noted.

An embodiment includes a post-reactor blend of linear low-density polyethylene copolymers (“LLDPE blend”) useful for making films, the LLDPE blend comprising a linear low-density ethylene/1-butene copolymer (“C4-LLDPE”), which has the following properties derived from being made by spray-dried, ethanol-modified Ziegler-Natta catalyst (sdEtOH/ZN): a density from 0.910 gram per cubic centimeter (g/cm³) to 0.935 g/cm³ and a melt index I₂ (190° C., 2.16 kg) from 0.8 gram per 10 minutes (g/10 min) to 2.8 g/10 min; and a linear low-density ethylene/1-hexene copolymer (“C6-LLDPE”), which has the following properties derived from being made by a bridged bis(indenyl)zirconocene catalyst: a density from 0.915 g/cm³ to 0.925 g/cm³ and a melt index I₂ (190° C., 2.16 kg) from 0.7 gram per 10 minutes (g/10 min) to 1.4 g/10 min.

The above-described post-reactor blend may have any one of limitations (i) to (iii): (i) wherein the C4-LLDPE has at least one, alternatively all but one, alternatively each of the following sdEtOH/ZN catalyst-derived properties: a polydispersity Mw/Mn greater than 4.3; a ratio of Mw of the fraction eluting between 93.0° C. to 120.0° C. divided by the Mw of the whole polymer eluting from 25.0° C. to 120.0° C. greater 2.0, alternatively greater than 2.1; CUMCDI<−0.5, wherein CUMCDI is cumulative molecular weight comonomer distribution index; a polymer fraction eluting from 25° to 37° C. of from 9.0 wt % to 12.0 wt % measured by iCCD; and a polymer fraction eluting from 75° to 93° C. of less than 44.5 wt % measured by iCCD, wherein iCCD is improved method for comonomer content distribution analysis; (ii) wherein the C6-LLDPE has at least one of the following bridged bis(indenyl)zirconocene catalyst-derived properties: a polydispersity Mw/Mn from 2.5 to 4.0; and a long chain branching (LCB) value from 0.001 long-chain branches per 1000 carbon atoms (LCB/1000C) to 0.094 LCB/1000C; and (iii) both limitations (i) and (ii). Methods for determining the CUMCDI, iCCD, and LCB values are described later.

The above-described post-reactor blend may comprise wherein the post-reactor blend is free of a low-density polyethylene, a reference linear low-density polyethylene that is different than the C4-LLDPE and the C6-LLDPE, or a high-density polyethylene; or wherein the post-reactor blend contains a low-density polyethylene, a reference linear low-density polyethylene that is different than the C4-LLDPE and the C6-LLDPE, or a high-density polyethylene.

Another embodiment includes a post-reactor method of making the above-described LLDPE blend, the method comprising: melting solids of the C4-LLDPE to form a melt thereof; melting solids of the C6-LLDPE to form a melt thereof; and mixing the melts together to form the LLDPE blend. Embodiments of the method comprise (i) mixing solids of the C4-LLDPE with solids of the C6-LLDPE to form a solids mixture thereof, and melting the solids mixture; or (ii) mixing solids of one of the C4-LLDPE or C6-LLDPE into a melt of the other of the C4-LLDPE or C6-LLDPE, and melting the solids; or (iii) preparing a melt of the C4-LLDPE and a melt of the C6-LLDPE separately, and mixing the melts together; or (iv) a combination of any two or more of embodiments (i) to (iii).

The above-described method may comprise, before the melting steps: making the C4-LLDPE having sdEtOH/ZN catalyst-derived properties by copolymerizing ethylene and 1-butene using a spray-dried, ethanol-modified Ziegler-Natta catalyst (“sdEtOH/ZN”), wherein the spray-dried, ethanol-modified Ziegler-Natta catalyst is prepared from the following materials: a titanium compound that is Ti(O-isopropyl)₄ or TiCl₄ or TiCl₃/AlCl₃; magnesium dichloride (MgCl₂); a hydrophobic fumed silica; a modifier compound comprising ethanol and, optionally, tetrahydrofuran; and an aluminum compound selected from a trialkylaluminum, an alkylaluminum dichloride, a dialkylaluminum chloride, or a combination of any two or more thereof; and making the C6-LLDPE having the bridged bis(indenyl)zirconocene catalyst-derived properties by copolymerizing ethylene and 1-hexene using a bridged bis(indenyl)zirconocene catalyst, wherein the bridged bis(indenyl)zirconocene catalyst is selected from the group consisting of: an ethylene bis(2-methyl indenyl)zirconium catalyst, a dimethylsilyl bis(2-methyl indenyl)zirconium catalyst, a diphenylsilyl bis(2-methyl indenyl)zirconium catalyst, a diphenylsilyl bis(2-methyl, 4-phenyl-indenyl)zirconium catalyst, and a diethylsilyl bis(2-methyl, 4-phenyl indenyl)zirconium catalyst. In some embodiments the bridged bis(indenyl)zirconocene catalyst is selected from the group consisting of: ethylene bis(4,5,6,7-tetrahydro-1-indenyl)zirconium dichloride, ethylene bis(4,5,6,7-tetrahydro-1-indenyl)zirconium dimethyl, dimethylsilyl bis(4,5,6,7-tetrahydro-1-indenyl)zirconium dichloride, dimethylsilyl bis(4,5,6,7-tetrahydro-1-indenyl)zirconium dimethyl, diphenylsilyl bis(4,5,6,7-tetrahydro-1-indenyl)zirconium dichloride, diphenylsilyl bis(4,5,6,7-tetrahydro-1-indenyl)zirconium dimethyl, diethylsilyl bis(4,5,6,7-tetrahydro-1-indenyl)zirconium dichloride, and diethylsilyl bis(4,5,6,7-tetrahydro-1-indenyl)zirconium dimethyl. In some embodiments the bridged bis(indenyl)zirconocene catalyst is rac-dimethylsilyl-bis(4,5,6,7-tetrahydro-1-indenyl)zirconium dichloride (CAS No. 126642-97-5) or rac-dimethylsilyl-bis(4,5,6,7-tetrahydro-1-indenyl)zirconium dimethyl, wherein rac means racemic. The copolymerizing steps are carried out separately in a gas phase polymerization reactor.

In some embodiments the bridged bis(indenyl)zirconocene catalyst is the rac-dimethylsilyl-bis(4,5,6,7-tetrahydro-1-indenyl)zirconium dichloride (CAS No. 126642-97-5) wherein rac means racemic. This catalyst also has the name rac-dimethylsilylene-bis(4,5,6,7-tetrahydro-1-indenyl)zirconium(IV) dichloride and the following structure:

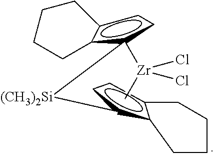

This catalyst is available commercially as XCAT™ EZ-100 catalyst from Univation Technologies, LLC, Houston, Texas (“UNIVATION”), a wholly-owned subsidiary of The Dow Chemical Company, Midland, Michigan.

Another embodiment includes a film comprising the above-described post-reactor blend.

The above-described film may comprise wherein the film is a monolayer film consisting of one layer and wherein the one layer comprises the post-reactor blend; or wherein the film is a multilayer film consisting of 3 to 12 layers wherein at least one of the 3 to 12 layers comprises the post-reactor blend.

The above-described film may comprise wherein the film is a multilayer film consisting of 3 to 12 layers comprising 2 to 4 outer layers and 1 to 8 core layers; wherein at least one outer layer independently comprises from 70 to 98 wt % of the C4-LLDPE and from 30 to 2 wt % of the C6-LLDPE, all based on the total weight of the C4-LLDPE+C6-LLDPE in the at least one outer layer; an wherein at least one core layer independently comprises from 80 to 100 wt % of the C4-LLDPE and from 20 to 0 wt % of the C6-LLDPE, all based on the total weight of the C4-LLDPE+C6-LLDPE in the at least one core layer.

Another embodiment includes a method of making the above-described multilayer film, the method comprising extruding through different ones of from 3 to 12 dies at least one melt of the LLDPE blend, and optionally through a different one of the dies a melt of the C4-LLDPE, thereby making the multilayer film consisting of 3 to 12 layers.

The above-described embodiments may be further described by the features and inventive example(s) that follow.

Relative to a first or second comparative LLDPE blend of comparative C4-LLDPE and C6-LLDPE (e.g., comparative examples CE1 or CE2 described later) wherein the comparative C4-LLDPE components are made by a comparative ethanol-free Ziegler Natta catalyst UCAT™ J, the inventive LLDPE blend of inventive C4-LLDPE and C6-LLDPE (e.g., inventive example IE1 described later), wherein the inventive C4-LLDPE component is made by the spray-dried, ethanol-modified Ziegler-Natta catalyst, has decreased average extruder die pressure during film forming. In addition, relative to a first or second comparative film (e.g., comparative film 1 or film 2 described later) made from the first or second comparative LLDPE blend, respectively, inventive film 4 made from the inventive LLDPE blend retains similar film puncture property and has decreased hot tack initiation temperature. Alternatively, relative to a third comparative LLDPE blend of comparative C4-LLDPE and C6-LLDPE (e.g., comparative example CE3), wherein the comparative C4-LLDPE component is made by the comparative ethanol-free Ziegler Natta catalyst UCAT™ J, the inventive LLDPE blend of inventive C4-LLDPE and C6-LLDPE (e.g., the inventive example IE1) has similar average extruder die pressure and yet relative to a third comparative film 3, made from the third comparative LLDPE blend, inventive film 4 made from the inventive LLDPE blend has increased film puncture property and decreased hot tack initiation temperature.

The LLDPE blend is a post-reactor blend of linear low-density polyethylene copolymers comprising a linear low-density ethylene/1-butene copolymer (C4-LLDPE) made by copolymerizing ethylene and 1-butene using a spray-dried, ethanol-modified Ziegler-Natta catalyst (“sdEtOH/ZN”) and a linear low-density ethylene/1-hexene copolymer (C6-LLDPE) made by copolymerizing ethylene and 1-hexene using a bridged bis(indenyl)zirconocene catalyst. The copolymerizing is carried out in a gas phase polymerization reactor and under gas phase polymerization conditions used in the UNIPOL™ Process. The UNIPOL™ Process has long been available from Univation Technologies, LLC, Houston, Texas, USA, and has been described in innumerable prior patents (“UNIVATION”). UNIVATION is a wholly-owned subsidiary of The Dow Chemical Company, Midland, Michigan, USA (“DOW”).

The LLDPE blend has a balance of processability properties required for making a blown film and mechanical properties and abuse properties required for the blown film to be able to withstand forces and loads bulk packaging films suffer during shipping and storage. This properties balance is achieved by combining sdEtOH/ZN catalyst properties comprising density and melt index I₂ of the C4-LLDPE described herein with bridged bis(indenyl)zirconocene catalyst-derived properties comprising density and melt index I₂ of the C6-LLDPE described herein. Additional catalyst-derived properties described elsewhere herein may be used to further describe the properties balance of the LLDPE blend. In turn the properties of the C4-LLDPE described herein are a result of the spray-dried, ethanol-modified Ziegler-Natta catalyst used to make it and the properties of the C6-LLDPE described herein are a result of the bridged bis(indenyl)zirconocene catalyst used to make it. This properties balance may be that described for the inventive examples later.

The chosen properties of the linear low-density ethylene/1-butene copolymer or “C4-LLDPE” are obtained, and the C4-LLDPE is made, by copolymerizing ethylene and 1-butene using the spray-dried, ethanol-modified Ziegler-Natta catalyst (sdEtOH/ZN). Although ethanol (EtOH) is called out in its name, the sdEtOH/ZN catalyst also contains THE as a modifier compound. Thus, the modifier compound of the inventive sdEtOH/ZN catalyst comprises a combination of THE and EtOH. Thus, another name for the catalyst is a spray-dried, (tetrahydrofuran-and-ethanol)-modified Ziegler-Natta catalyst (“sd(THF & EtOH)/ZN”). In some embodiments the combination of THE and EtOH consists of THE/EtOH in a weight/weight ratio from 2:1 to 1:2, alternatively from 1.5:1.0 to 1.0:1.5, alternatively from 1.1:1.0 to 1.0:1.1, e.g., 1.0:1.0. In some such embodiments the THE/EtOH are in a weight/weight ratio from 2:1 to 1:2, alternatively from 1.5:1.0 to 1.0:1.5, alternatively from 1.1:1.0 to 1.0:1.1, e.g., 1.0:1.0. The spray-dried, ethanol-modified Ziegler-Natta catalyst is a titanium-based catalyst supported on magnesium dichloride and a hydrophobic fumed silica. The catalyst is made by contacting a spray-dried, ethanol-modified titanium-based procatalyst with an activator, such as triethylaluminum, in an inert hydrocarbon liquid such as isopentane, hexanes, toluene, or mineral oil. The spray-dried, ethanol-modified titanium-based procatalyst may be prepared from the following materials: a titanium compound that is Ti(O-isopropyl)₄ or TiCl₄ or TiCl₃/AlCl₃; magnesium dichloride (MgCl₂); a hydrophobic fumed silica; a modifier compound comprising ethanol and, optionally, tetrahydrofuran; and an aluminum compound selected from a trialkylaluminum, an alkylaluminum dichloride, a dialkylaluminum chloride. The trialkylaluminum may be triethylaluminum (“TEA” or “TEAl”) or tri(n-hexyl)aluminum (TnHAl), the alkylaluminum dichloride may be ethylaluminum dichloride (EADC), and the dialkylaluminum chloride may be diethylaluminum chloride (DEAC). The combination of any two or more thereof may be TEA and EADC or DEAC and TnHAl. The preparation may be carried out in an inert hydrocarbon liquid. The hydrophobic fumed silica may be made by treating an untreated silica with a silicon-based hydrophobing agent of the type described in U.S. Pat. No. 11,248,066 B2, such as dimethyldichlorosilane. The hydrophobic fumed silica may be TS-610 from Cabot Corp. The catalyst may be the spray-dried, ethanol-modified Ziegler-Natta catalyst described below in the EXAMPLES. After copolymerizing is complete and prior to post-reactor blending, post-reactor processing steps deactivate the catalyst and remove the ethanol such that the C4-LLDPE is free of active catalyst and free of ethanol and any other volatile organic compounds. The C4-LLDPE may contain nonvolatile remnants of the catalyst, such as inactive Ti and Mg salts and silica.

The C4-LLDPE, which contributes to the aforementioned properties balance of the LLDPE blend, has the following sdEtOH/ZN catalyst-derived properties: a density from 0.910 gram per cubic centimeter (g/cm³) to 0.935 g/cm³, alternatively from 0.915 to 0.925 g/cm³, alternatively from 0.918 to 0.922 g/cm³; and a melt index I₂ (190° C., 2.16 kg) from 0.8 gram per 10 minutes (g/10 min) to 2.8 g/10 min, alternatively from 1.5 to 2.5 g/10 min, alternatively from 1.7 to 2.2 g/10 min.

In some embodiments the C4-LLDPE also has at least one, alternatively all but one, alternatively each of the following sdEtOH/ZN catalyst-derived properties: a polydispersity Mw/Mn greater than 4.3; a ratio of Mw of the fraction eluting between 93.0° C. to 120.0° C. divided by the Mw of the whole polymer eluting from 25.0° C. to 120.0° C. greater 2.0, alternatively greater than 2.1; CUMCDI<−0.5, wherein CUMCDI is cumulative molecular weight comonomer distribution index; a polymer fraction eluting from 25° to 37° C. of from 9.0 wt % to 12.0 wt % measured by iCCD; and a polymer fraction eluting from 75° to 93° C. of less than 44.5 wt % measured by iCCD, wherein iCCD is improved method for comonomer content distribution analysis.

The chosen properties of the linear low-density ethylene/1-hexene copolymer or “C6-LLDPE” are obtained, and the C6-LLDPE is made, by copolymerizing ethylene and 1-hexene using a bridged bis(indenyl)zirconocene catalyst. The bridged bis(indenyl)zirconocene catalyst is a metallocene catalyst wherein the metal atom is zirconium and the two cyclopentadienyl ligands of conventional metallocenes are replaced by a single bidentate ligand comprising a bridged bis(substituted indenyl) group. The bridged bis(indenyl)zirconocene catalyst may be selected from the group consisting of: an ethylene bis(2-methyl indenyl)zirconium catalyst, a dimethylsilyl bis(2-methyl indenyl)zirconium catalyst, a diphenylsilyl bis(2-methyl indenyl)zirconium catalyst, a diphenylsilyl bis(2-methyl, 4-phenyl-indenyl)zirconium catalyst, and a diethylsilyl bis(2-methyl, 4-phenyl indenyl)zirconium catalyst. The bridged bis(indenyl)zirconocene catalyst is made by contacting a bridged bis(substituted indenyl)zirconium X₂ procatalyst with an activator (e.g., MAO), wherein X is halogen, alkyl, or benzyl; alternatively chloride or methyl; alternatively chloride. The bridged bis(substituted indenyl)zirconium X₂ procatalyst may be selected from the group consisting of: ethylene bis(2-methyl indenyl)zirconium dichloride, dimethylsilyl bis(2-methyl indenyl)zirconium dichloride, diphenylsilyl bis(2-methyl indenyl)zirconium dichloride, diphenylsilyl bis(2-methyl, 4-phenyl-indenyl)zirconium dichloride, and diethylsilyl bis(2-methyl, 4-phenyl indenyl)zirconium dichloride. These are reported in numerous patents including in paragraph [0095] of US 2018/0079836 A1 and paragraph [0111] of US 2017/0233507 A1. Alternatively the bridged bis(indenyl)zirconocene catalyst may be selected from the group consisting of: ethylene bis(4,5,6,7-tetrahydro-1-indenyl)zirconium dichloride, ethylene bis(4,5,6,7-tetrahydro-1-indenyl)zirconium dimethyl, dimethylsilyl bis(4,5,6,7-tetrahydro-1-indenyl)zirconium dichloride, dimethylsilyl bis(4,5,6,7-tetrahydro-1-indenyl)zirconium dimethyl, diphenylsilyl bis(4,5,6,7-tetrahydro-1-indenyl)zirconium dichloride, diphenylsilyl bis(4,5,6,7-tetrahydro-1-indenyl)zirconium dimethyl, diethylsilyl bis(4,5,6,7-tetrahydro-1-indenyl)zirconium dichloride, and diethylsilyl bis(4,5,6,7-tetrahydro-1-indenyl)zirconium dimethyl. These bridged bis(indenyl)zirconocene catalysts are made by contacting a bridged bis(4,5,6,7-tetrahydro-1-indenyl)zirconium X₂ procatalyst with an activator (e.g., MAO), wherein X is halogen, alkyl, or benzyl; alternatively chloride or methyl; alternatively chloride. The bridged bis(indenyl)zirconium X₂ procatalyst may be selected from the group consisting of: ethylene bis(4,5,6,7-tetrahydro-1-indenyl)zirconium dichloride, ethylene bis(4,5,6,7-tetrahydro-1-indenyl)zirconium dimethyl, dimethylsilyl bis(4,5,6,7-tetrahydro-1-indenyl)zirconium dichloride, dimethylsilyl bis(4,5,6,7-tetrahydro-1-indenyl)zirconium dimethyl, diphenylsilyl bis(4,5,6,7-tetrahydro-1-indenyl)zirconium dichloride, diphenylsilyl bis(4,5,6,7-tetrahydro-1-indenyl)zirconium dimethyl, diethylsilyl bis(4,5,6,7-tetrahydro-1-indenyl)zirconium dichloride, and diethylsilyl bis(4,5,6,7-tetrahydro-1-indenyl)zirconium dimethyl. The C6-LLDPE may be product EZP-2010, which is made by the UNIPOL™ PE Process using XCAT™ EZ-100 catalyst available from UNIVATION. The C6-LLDPE may be product EZP-2010, which is made by the UNIPOL™ PE Process using XCAT™ EZ-100 catalyst. After copolymerizing is complete and prior to post-reactor blending, post-reactor processing steps deactivate the catalyst such that the C6-LLDPE is free of active catalyst and volatile organic compounds. The C6-LLDPE may contain nonvolatile remnants of the bridged bis(indenyl)zirconocene catalyst, such as an inactive Zr salt.

The C6-LLDPE, which contributes to the aforementioned properties balance of the LLDPE blend, has the following bridged bis(indenyl)zirconocene catalyst-derived properties: a density from 0.915 g/cm³ to 0.925 g/cm³, alternatively from 0.920 g/cm³ to 0.924 g/cm³; and a melt index I₂ (190° C., 2.16 kg) from 0.7 gram per 10 minutes (g/10 min) to 1.4 g/10 min, alternatively 0.9-1.2 g/10 min. In some embodiments the C6-LLDPE has a density of 0.922 g/cm³ and a melt index of 1.0 g/10 min.

In some embodiments the C6-LLDPE also has at least one, alternatively all but one, alternatively each of the following bridged bis(indenyl)zirconocene catalyst-derived properties (C) to (D): (C) a polydispersity Mw/Mn from 2.5 to 4.0; (D) a long chain branching (LCB) value from 0.001 long-chain branches per 1000 carbon atoms (LCB/1000C) to 0.094 LCB/1000C. In some embodiments the C6-LLDPE is the EZP-2010 product.

It is believed that a reference LLDPE blend of a reference linear low-density ethylene/1-butene copolymer (reference C4-LLDPE) made using a different Ziegler-Natta catalyst (free of ethanol) and a reference linear low-density ethylene/1-hexene copolymer (reference C6-LLDPE) made using a different metallocene catalyst (free of a bridged indenyl ligand) would fail to achieve the present properties balance.

A post-reactor method of making the above-described LLDPE blend, the method comprising: melting solids of the C4-LLDPE to form a melt thereof; melting solids of the C6-LLDPE to form a melt thereof; and mixing the melts together to form the LLDPE blend.

A method of making a film comprising the above-described LLDPE blend comprises extruding at least one melt of the LLDPE blend as a film having at least one layer. In a multilayer film laminate embodiment the method comprises melting one or more embodiments of the LLDPE blend, and optionally a singleton C4-LLDPE to give one or more melts thereof, and extruding the melts through separate extruders configured for forming a multilayer film laminate. An Alpine 7 film line may be used to do this wherein the multilayer film laminate consists of 7 layers as shown in FIG. 2.

In a blown film embodiment, the method comprises melting the LLDPE blend to give a melt thereof, extruding the melt through a die configured for forming a bubble to make a bubble of the LLDPE copolymer, and blowing (inflating) the bubble with a film-blowing machine, thereby making the blown film. The LLDPE blend has a balance of processability properties required for making a blown film and mechanical properties and abuse properties required for the blown film to be able to withstand forces and loads bulk packaging films suffer during shipping and storage.

Film making methods are well known. For example, see LyondellBasell, A Guide to Polyolefin Film Extrusion, Publication 6047/1004 (available at lyb.com) and Qenos Pty, Ltd., Film Extrusion and Conversion—Technical Guide (July 2015) (available at qenos.com).

A film comprising the above-described LLDPE blend. The film is especially useful for packaging applications, such as food packaging made by standard film blowing methods and equipment.

Some embodiments of the film consist of a single layer (“monolayer film”), wherein the single layer is composed of the LLDPE blend. There is no need to illustrate this simple construction.

Other embodiments of the film consist of 2 or more layers (“multilayer film”), wherein at least one of the 2 or more layers is composed of the inventive LLDPE blend and each of the other of the 2 or more layers independently is composed of a polyolefin composition selected from a polypropylene, a low-density polyethylene (LDPE), a single linear low-density polyethylene (LLDPE), a high-density polyethylene (HDPE), the inventive LLDPE blend, or any combination of two or more such polyolefin compositions thereof. In some embodiments at least two of the 2 or more layers are independently composed of the inventive LLDPE blend.

Some embodiments of the multilayer film may consist of 3 to 12 layers, alternatively 5 to 12 layers, alternatively 6 to 12 layers, alternatively 7 layers, wherein at least one of the aforementioned layers is composed of the LLDPE blend. In some such embodiments the polyolefin composition of any two or more consecutive layers is different. In other embodiments the polyolefin composition of two or more consecutive layers is the same, and this is referred to herein as a “like layer grouping”.

In some embodiments the film consists of 3 or more layers wherein at least one of 3 or more the layers is a core layer (inner layer) that is composed of a low-density polyethylene (LDPE) and at least two of the 3 or more layers “sandwich” the core layer and are independently composed of the same or different LLDPE blends.

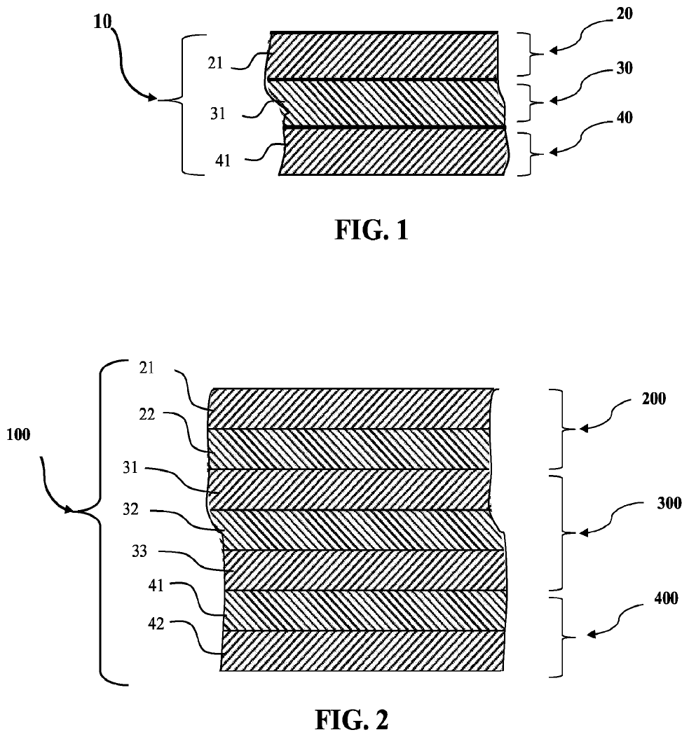

An embodiment of the multilayer film comprising 3 layers is illustrated by 3-layer film 10 in FIG. 1. The 3-layer film 10 comprises a first outer layer (a skin layer or top layer) 20; a core layer (a middle layer) 30; and a second outer layer (a skin layer or bottom layer) 40. The core layer 30 is disposed in between the top layer 20 and the bottom layer 40, i.e., the two layers 20 and 40 sandwich the core layer 30. The top layer 20, the core layer 30, and the bottom layer 40 are contacted and bonded together to form the 3-layer film 10. The term “core layer” refers to any internal layer in a multilayer film; and the phrase “skin layer” refers to an outermost layer of a multilayer film.

Each of the layers 20, 30 and 40 of the multilayer film 10 in FIG. 1 is made as a distinct monolayer. Such a 3-layer film 10 in FIG. 1 is made by a film forming process combining 3 distinct layers in the following sequential arrangement: 20/30/40. All layers may be made simultaneously or sequentially or any combination thereof. Reference numerals 21, 32, and 41 are used in FIG. 1 simply to indicate the layers 20, 30, and 40 are made as distinct monolayers in the film forming process (whether simultaneously or sequentially). However, because the layers 20, 30, and 40 (21, 31, and 41) are made from melts of polyethylene compositions, these layers may undergo some interfacial mixing such that, in final form, a cross-section of the 3-layer film 10 may appear as having fewer than three total layers.

In other embodiments the 3-layer film 10 in FIG. 1 is a section of a larger multilayer film having from 4 to 12 total layers comprising 4 or more total layers. The layers 20, 30, and 40 may comprise any three consecutive layers of the multilayer film having 4 to 12 total layers. In some such embodiments layer 20 of 3-layer film 10 is an outer layer or top layer and layers 30 and 40 are core layers or inner layers of the multilayer film having from 4 to 12 total layers. In other embodiments each of layers 20, 30, and 40 are core layers or inner layers of the multilayer film having from 4 to 12 total layers.

In other embodiments the multilayer film has from 4 to 12 total layers An embodiment thereof is illustrated in 7-layer film 100 in FIG. 2.

In FIG. 2 like layer grouping 200 consists of like outer layers 21 and 22; like layer grouping 300 consists of like core layers 31, 32, and 33; and like layer grouping 400 consists of like outer layers 41 and 42. Layers 21 and 42 are outermost layers and layers 22 and 41 are outer layers immediately adjacent the outermost layers 21 and 42, respectively. Outer layer 22 is disposed between the outermost layer 21 and the core layer 31. Outer layer 41 is disposed between the outermost layer 42 and the core layer 33. Core layer 32 is disposed between core layers 31 and 33. In some embodiments the core layers 31, 32, and 33 are independently composed of LLDPE that is not part of the inventive LLDPE blends and the layers outer 21, 22, 41, and 42 are independently composed of the same or different inventive LLDPE blends.

The 7-layer film 100 in FIG. 2 is made by a film forming process combining 7 distinct layers in the following sequential arrangement: 21/22/31/32/33/41/42. This may be done by a 7-layer film line such as an Alpine 7-layer film extruder.

In some embodiments of the multilayer film (e.g., multilayer films 10 and 100 of FIGS. 1 and 2) at least one, alternatively each outer layer (e.g., layers 20 and 40 in the case of FIG. 1 or layers 21, 22, 41, and 42 in the case of FIG. 2), independently comprises from 70 to 98 wt % of the C4-LLDPE and from 30 to 2 wt % of the C6-LLDPE, alternatively from 80 to 97 wt % of the C4-LLDPE and from 20 to 3 wt % of the C6-LLDPE, alternatively from 86 to 94 wt % of the C4-LLDPE and from 14 to 6 wt % of the C6-LLDPE, alternatively 90 wt % of the C4-LLDPE and 10 wt % of the C6-LLDPE, all based on the total weight of the C4-LLDPE+C6-LLDPE in the outer layer.

In some embodiments of the multilayer film (e.g., the multilayer films 10 and 100 of FIGS. 1 and 2), at least one, alternatively each core layer (e.g., the middle layer 30 in the case of FIG. 1, or one or more of core layers 31, 32, and 33 in the case of FIG. 2), comprises from 80 to 100 wt % of the C4-LLDPE and from 20 to 0 wt % of the C6-LLDPE, alternatively from 85 to 100 wt % of the C4-LLDPE and from 15 to 0 wt % of the C6-LLDPE, alternatively from 95 to 100 wt % of the C4-LLDPE and from 5 to 0 wt % of the C6-LLDPE, alternatively 100 wt % of the C4-LLDPE and 0 wt % of the C6-LLDPE, all based on the total weight of the C4-LLDPE+C6-LLDPE in core layer.

In some embodiments at least one layer of the film also contains a polyolefin composition that is not part of the inventive LLDPE blend. Examples are the reference LLDPE, a low-density polyethylene (LDPE), or a high-density polyethylene (HDPE). In some embodiments the core layer 30 of the 3-layer film 10 in FIG. 1 or the core layers 31, 32, and 33 of the 7-layer film 100 in FIG. 2 is composed of a reference LLDPE that is not the C4-LLDPE or the C6-LLDPE and the layers 20 and 40 in FIG. 1 and the layers 21, 22, 41, and 42 in FIG. 2 are independently composed of the same or different inventive LLDPE blends.

The method of making the film, the method comprising extruding through at least two different dies at least one melt of the LLDPE blend, and optionally extruding a melt of the C4-LLDPE through at least one different die, thereby making the multilayer film having 3 to 12 layers. The polyethylene film may be made using any film extrusion line configured for making a multilayer film or any blown-film-line machine configured for making polyethylene films.

The film extrusion line for making a multilayer film may be a film extrusion line configured for making a multilayer film having 3, 5, 7, 9, or up to 12 layers. An example of such a film extrusion line is an Alpine 7 film extruder configured for making a 7-layer multilayer film.

The blown film machine may be configured with a feed hopper in fluid communication with an extruder in heating communication with a heating device capable of heating a polyethylene in the extruder to a temperature of up to 500° C. (e.g., 430° C.), and wherein the extruder is in fluid communication with a die having an inner diameter of 20.3 centimeters (8 inches) and a fixed die gap (e.g., 1.778 millimeter gap (70 mils)), a blow up ratio of 2.5:1, and a Frost Line Height (FLH) of 76±10 centimeters (30±4 inches) from the die. Step (a) may be done in the feed hopper. Steps (b) and (c) may be done in the extruder and at a temperature of 4000 to 450° C. (e.g., 430° C.). Step (d) may be done in the die and after exiting the die. The machine may have capacity of a feed rate of (A) and (B), and production rate of film, from 50 to 200 kilograms (kg) per hour, e.g., 91 kg (201 pounds) per hour at 430° C.

The film is useful for making containers and wraps that have at least one enhanced optical property. Examples of such containers are bags such as ice bags and grocery bags. Examples of such wraps are stretch films, meat wraps, and food wraps.

The film description focuses on packaging applications, but the applications of the LLDPE blend are not limited to packaging films or even films in general. Useful applications of the LLDPE blend also include a variety of non-film articles such as car parts.

Preparation Method: prepare test specimens, test plaques, or test sheets according to ASTM D4703-10, Standard Practice for Compression Molding Thermoplastic Materials into Test Specimens, Plaques, or Sheets.

Density Test Method: measure according to ASTM D792-13, Standard Test Methods for Density and Specific Gravity (Relative Density) of Plastics by Displacement, Method B (for testing solid plastics in liquids other than water, e.g., in liquid 2-propanol). Report results in units of grams per cubic centimeter (g/cm³).

Melt Index (“I₂”) Test Method: for ethylene-based (co)polymer is measured according to ASTM D1238-13, using conditions of 190° C. J2.16 kg, formerly known as “Condition E”.

Molecular weights Mw (weight-average), Mn (number-average), and Mz (z-average) are measured according to the High Temperature Gel Permeation Chromatography (GPC) Test Method described below.

High Temperature Gel Permeation Chromatography (GPC) Test Method: was performed on the specimens to determine the Molecular Weight Distributions (MWD) of the samples and the samples' corresponding moments (Mn, Mw and Mz). The chromatographic system used to measure GPC included a Polymer Char GPC-IR high temperature GPC chromatograph (available from Polymer Char, Valencia, Spain) equipped with a 4-capillary differential viscometer detector and a IR5 multi-fixed wavelength infrared detector (available from Polymer Char). A Precision Detectors 2-angle laser light scattering detector Model 2040 (available from Precision Detectors, currently Agilent Technologies) was added to the chromatographic system. The 15-degree angle of the light scattering detector was used for calculation purposes. Data collection was performed using GPC One software (available from Polymer Char). The system was equipped with an on-line solvent degas device (available from Agilent Technologies).

Both the detector compartments and the column compartment of the chromatograph were operated at 150° C. The columns used were 4 PLgel Mixed A 7.5 mm×300 mm, 20-micron columns (Agilent Technology). The chromatographic solvent used was 1,2,4 trichlorobenzene (TCB) which contained 200 ppm of butylated hydroxytoluene (BHT). The solvent source was nitrogen sparged. The injection volume used for each of the injection samples was 200 μL and the flow rate was 1.0 mL/min. Otherwise stated, samples were prepared in a semi-automatic manner with the PolymerChar “Instrument Control” Software, wherein the samples were weight-targeted at 2 mg/mL, and the solvent (contained 200 ppm BHT) was added to a pre nitrogen-sparged septa-capped vial, via the PolymerChar high temperature autosampler. The samples were dissolved for 2 hr at 160° C. under “low speed” shaking.

For conventional molecular weight measurements, the GPC column set was calibrated with 21 narrow molecular weight distribution polystyrene standards (available from Polymer Laboratories, now Varian) with molecular weights ranging from 580 to 8,400,000 and were arranged in 6 “cocktail” mixtures. The polystyrene standards were prepared at 0.025 g in 50 mL of solvent for molecular weights >1,000,000; and 0.05 g in 50 mL of solvent for molecular weights <1,000,000. The polystyrene standards were dissolved at 80° C. with gentle agitation for 30 min. The narrow standards mixtures were run first and in decreasing order from the highest molecular weight component to minimize degradation of the standards. The peak molecular weights of the polystyrene standards were converted to polyethylene molecular weights using the following Equation (1): M_{polyethylene}=A*(M_{polystyrene})\hat{ }B Equation (I), where in Equation (I), “M” is molecular weight of polystyrene or polyethylene; value “A” is a positive number of <0.500; and value “B” is equal to 1.000. A fifth order polynomial was used to fit the respective polystyrene calibration points. The MWD can be also expressed in integral form as cumulative weight distribution versus log (molecular weight) (Streigel et al., Modern Size Exclusion Liquid Chromatography, 2^{nd} edition, P450) from zero to 1.00 for the entire MWD range from lowest MW to highest MW.

A calibration for the IR5 detector rationing was performed using at least ten ethylene-based polymer short chain branching (SCB) standards, where octene is used as the comonomer. Polymer properties for the SCB standards are shown in the SCB Standards Table below. Each of the SCB standards are made by single-site metallocene catalyst from a single reactor in solution process (polyethylene homopolymer and ethylene/octene copolymers) of a narrow short chain branching distribution (SCBD) and known comonomer content (as measured by ¹³C NMR Method, Qiu et al., Anal. Chem. 2009, 81, 8585-8589), ranging from homopolymer (0 SCB/1000 total C) to approximately 40 SCB/1000 total C, where total C=carbons in backbone+carbons in branches. Each SCB standard had a weight-average molecular weight from 36,000 g/mole to 126,000 g/mole measured by GPC. The Mw of 36,000 g/mole indicates polymer chains having approximately 1,290 equivalent ethylene-derived constituent units and the Mw of 126,000 g/mole indicates polymer chains having approximately 4,510 equivalent ethylene-derived constituent units. Also, each SCB standard had a molecular weight distribution (Mw/Mn) from 2.0 to 2.5 as described in the below SCB Standards Table.

SCB Standards Table:

| Octene Comonomer | | | |
|---|---|---|---|
| (wt %) | SCB/1000 Total C | Mw | Mw/Mn |
| 23.1 | 28.9 | 37,300 | 2.22 |
| 14.0 | 17.5 | 36,000 | 2.19 |
| 0.0 | 0.0 | 38,400 | 2.20 |
| 35.9 | 44.9 | 42,200 | 2.18 |
| 5.4 | 6.8 | 37,400 | 2.16 |
| 8.6 | 10.8 | 36,800 | 2.20 |
| 39.2 | 49.0 | 125,600 | 2.22 |
| 1.1 | 1.4 | 107,000 | 2.09 |
| 14.3 | 17.9 | 103,600 | 2.20 |
| 9.4 | 11.8 | 103,200 | 2.26 |

A “IR5 Area Ratio” (or “IR5 Methyl Channel Area/IR5 Measurement Channel Area”) of a “baseline-subtracted area response of a IR5 methyl channel sensor” to a “baseline-subtracted area response of IR5 measurement channel sensor” was calculated for each of the SCB standards (standard filters and filter wheel are as supplied by PolymerChar). A linear fit of the SCB frequency versus the IR5 Area Ratio was constructed in the form of the following Equation (II): SCB/1000 total C=A₀+[A₁×(IR5_{Methyl Channel Area}/IR5_{Measurement Channel Area})] Equation (II) where A₀ is the SCB/1000 total C intercept at an IR5 Area Ratio of zero, and A₁ is the slope of the SCB/1000 total C versus the IR5 Area Ratio. A₁ represents the increase in the SCB/1000 total C as a function of the IR5 Area Ratio. The IR5 Area Ratio is equal to a IR5 Height Ratio for narrow PDI and narrow SCBD standard materials.

A series of “linear baseline-subtracted chromatographic heights” for the chromatogram generated by the “IR5 methyl channel sensor” was established as a function of column elution volume to generate a “baseline-corrected chromatogram (methyl channel)”. A series of linear baseline-subtracted chromatographic heights for the chromatogram generated by the “IR5 measurement channel” of the IR-5 detector was established as a function of column elution volume to generate a “base-line-corrected chromatogram (measurement channel”).

A “IR5 Height Ratio” of the “baseline-corrected chromatogram (methyl channel)” to the “baseline-corrected chromatogram (measurement channel)” was calculated at each column elution volume index (each equally-spaced index, representing 1 data point per second at 1 mL/min elution flow rate) across the sample integration bounds. The IR5 Height Ratio was multiplied by the coefficient A₁, and the coefficient A₀ was added to this result, to produce the predicted SCB frequency of the sample. The result was converted into mole percent comonomer using the following Equation (III): Mole Percent Comonomer={SCB_{f}/[SCB_{f}+((1000−SCB_{f}*Length of comonomer)/2)]}*100 Equation (III), where “SCB_{f}” is the “SCB per 1000 total C”, and the “Length of comonomer” is 8 which is the number of carbons of octene.

The comonomer composition versus MWD was reported as octene comonomer. Each elution volume index was converted to a molecular weight (Mwᵢ) value using the method described above; Equation (II). The “Mole Percent Comonomer (y axis)” was calculated as a function of Log (Mwᵢ), and the slope was calculated between the cumulative weight fraction at 0.10 to 0.95. (An EXCEL linear regression was used to calculate the slope and R² (coefficient of linear fitting) between the cumulative weight fraction at 0.10 to 0.95). This slope is defined as the cumulative molecular weight comonomer distribution index (CUMCDI).

iCCD Test Method: “iCCD”, is an improved method for comonomer content distribution (CCD) analysis; and is based on the method described in WO2017040127A1. The test method was performed with crystallization elution fractionation (CEF) instrumentation (available from Polymer Char) equipped with an IR-5 detector and a two-angle precision detector light scattering detector Model 2040 (available from Agilent Technology). Ortho-dichlorobenzene (ODCB, 99% anhydrous grade or technical grade) was used as solvent. Silica gel 40 (with a particle size of 0.2 mm to ˜0.5 mm; available from EMD Chemicals) can be used to dry the ODCB solvent. Dried silica was packed into three emptied HT-GPC columns (with dimensions of 300 mm×7.5 mm (ID)) to further purify the ODCB solvent as eluent. The CEF instrument is equipped with an autosampler with nitrogen (N₂) purging capability. ODCB was sparged with dried N₂ for 1 hr before use.

A sample was prepared using the autosampler at 4 mg/mL (unless otherwise specified) under shaking at 160° C. for 1 hour. The injection volume of the sample was 300 microliters (μL). The temperature profile of iCCD was as follows: crystallization at 3° C./minute from 105° C. to 30° C.; thermal equilibrium at 30° C. for 2 minutes (including Soluble Fraction Elution Time being set as 2 minutes); elution at 3° C./minute from 30° C. to 140° C. The flow rate of the sample during crystallization is 0.0 mL/minute. The flow rate of the sample during elution is 0.50 mL/minute. The data was collected at one data point/second.

The iCCD column used was a 15 cm (length)×¼ in internal diameter (ID) stainless tubing packed with gold coated nickel particles (Bright 7GNM8-NiS; available from Nippon Chemical Industrial Co.). The column packing and conditioning was carried out using a slurry method according to the method described in WO2017040127A1. The final pressure with trichlorobenzene (TCB) slurry packing was 150 bar (10 MPa).

The column temperature calibration was performed by using a mixture of: (i) 1.0 mg/mL of a linear homopolymer polyethylene (a polyethylene having a zero comonomer content, a melt index (I₂) of 1.0 g/cm³, and a polydispersity (M_{w}/Mₙ) of approximately 2.6 as determined by the GPC test method described above) as a “reference material”; and (ii) 0.5 mg/mL of Eicosane in ODCB. The iCCD temperature calibration consisted of four steps: (1) calculating the delay volume defined as the temperature offset between the measured peak elution temperature of Eicosane minus 30.00° C.; (2) subtracting the temperature offset of the elution temperature from iCCD raw temperature data (it is noted that this temperature offset is a function of experimental conditions, such as elution temperature, elution flow rate, etc.); (3) creating a linear calibration line transforming the elution temperature across a range of 30.00° C. and 140.00° C. so that the linear homopolymer polyethylene reference material had a peak temperature at 101.0° C., and Eicosane had a peak temperature of 30.0° C.; (4) for the soluble fraction measured isothermally at 30° C., the elution temperature below 30.0° C. is extrapolated linearly by using the elution heating rate of 3° C./min according to the method described in U.S. Pat. No. 9,688,795. GPCOne software (available from PolymerChar) is used to generate SCBD distribution curve dWi/dT where Wᵢ is the mass at Tᵢ, where Tᵢ is the elution temperature after calibration.

The elution fraction, in wt %, is determined at a specific elution temperature range. It is defined as the area of the baseline subtracted iCCD profile in a specific temperature range divided by the total integrated area of the baseline subtracted iCCD elution chromatogram multiplying by 100%. For example, wt % (in the elution temperature range of 75.0° C. to 93.0° C.) is defined as the area of the baseline subtracted iCCD chromatogram eluting from 75.0° C. to 93.0° C. divided by the total integrated area of iCCD chromatogram (from 25.0° C. to 120.0° C.) multiplied by 100%.

The comonomer content versus elution temperature of iCCD was constructed by using 12 reference materials (ethylene homopolymer and ethylene-octene random copolymer made with single site metallocene catalyst, having ethylene equivalent weight average molecular weight ranging from 35,000 to 128,000) with solution process. All of these reference materials were analyzed the same way as specified previously at 4 mg/mL. The correlation between comonomer mol fraction versus elution temperature (T in Celsius) follows the following expression: ln(1−comonomer mol fraction)=−208.328/(elution temperature+273.12)+0.55846.

The composition distribution index (CDBI) is defined as the weight percent of the polymer molecules having a co-monomer content within +/−50 percent of the median total molar co-monomer content (as reported in WO 93/03093). The CDBI of polyolefins can be conveniently calculated from the SCBD data obtained from the techniques known in the art, such as, for example, temperature rising elution fractionation (“TREF”) as described, for example, by Wild, et al., Journal of Polymer Science, Poly. Phys. Ed., Vol. 20, 441 (1982); L. D. Cady, “The Role of Comonomer Type and Distribution in LLDPE Product Performance,” SPE Regional Technical Conference, Quaker Square Hilton, Akron, OH, 107-119 (Oct. 1-2, 1985); and in U.S. Pat. Nos. 4,798,081 and 5,008,204.

Herein, CDBI is calculated accordingly by using short chain branching distribution measured by the iCCD method and with the comonomer composition correlation versus elution temperature as described above.

Molecular weight of polymer and the molecular weight of the polymer fractions was determined directly from a light scattering (LS) detector (Precision Detector, 90 degree angle) and concentration detector (IR-5) giving a Rayleigh-Gans-Debys approximation (Striegel and Yau, Modern Size Exclusion Liquid Chromatogram, Page 242 and Page 263) by assuming a form factor of 1 and all the virial coefficients equal to zero. Baselines were subtracted for both LS detector and concentration detector. Integration windows are set to integrate all the chromatograms in the elution temperature (temperature calibration is specified above) range of from 23.0° C. to 120° C.

The calculation of molecular weight (Mw) from iCCD includes the following steps: Step (1): Measuring the interdetector offset. The offset is defined as the geometric volume offset between LS with respect to concentration detector. It is calculated as the difference in the elution volume (mL) of polymer peak between concentration detector and LS chromatograms. It is converted to the temperature offset by using elution thermal rate and elution flow rate. A linear high density polyethylene (having zero comonomer content, Melt index (I₂) of 1.0, polydispersity M_{w}/Mₙ approximately 2.6 by conventional gel permeation chromatography) is used. Same experimental conditions as the normal iCCD method above are used except the following parameters: crystallization at 10° C./min from 140° C. to 137° C., the thermal equilibrium at 137° C. for 1 minute as Soluble Fraction Elution Time, soluble fraction (SF) time of 7 minutes, elution at 3° C./min from 137° C. to 142° C. The flow rate during crystallization is 0.0 ml/min. The flow rate during elution is 0.80 ml/min. Sample concentration is 1.0 mg/ml. Step (2): Each datapoint in LS chromatogram is shifted to correct for the interdetector offset before integration. Step (3): Baseline subtracted LS and concentration chromatograms are integrated for the whole eluting temperature range of the Step (1). The MW detector constant is calculated by using a known MW HDPE sample in the range of 100,000 to 140,000 Mw and the area ratio of the LS and concentration integrated signals. Step (4): Mw of the polymer was calculated by using the ratio of integrated light scattering detector (90-degree angle) to the concentration detector and using the MW detector constant. With the measured MW detector constant, NIST NBS 1475a analyzed with same method specified in (1) above gave molecular weight of 58,000. Mw ratio is calculated as the Mw of the fraction eluting between 93.0° C. to 120.0° C. divided by the Mw of the whole polymer (eluting from 25.0° C. to 120.0° C.).

Long Chain Branching (LCB) Value Test Method: the amount of the long chain branching (LCB) occurring in any LLDPE is measured using nuclear magnetic resonance (NMR) spectroscopy as described in publications (A) to (C): (A) Z. Zhou, S. Pesek, J. Klosin, M. Rosen, S. Mukhopadhyay, R. Cong, D. Baugh, B. Winniford, H. Brown, K. Xu, “Long chain branching detection and quantification in LDPE with special solvents, polarization transfer techniques, and inverse gated 13C NMR spectroscopy”, Macromolecules, 2018, 51, 8443, which includes a teaching of a pulse sequence; (B) Z. Zhou, C. Anklin, R. Cong, X. Qiu, R. Kuemmerle, “Long-chain branch detection and quantification in ethylene-hexene LLDPE with 13C NMR”, Macromolecule, 2021, 54, 757; and (C) Z. Zhou, C. Anklin, R. Kuemmerle, R. Cong, X. Qiu, J. DeCesare, M. Kapur, R. Patel, “Very sensitive 13C NMR method for the detection and quantification of long-chain branches in ethylene-hexene LLDPE”, Macromolecule, 2021, 54, 5985.

Film Test Method for Clarity: measure optical property clarity according to ASTM D1746-15, Standard Test Method for Transparency of Plastic Sheeting. Measure clarity using the BYK-Gardner Haze-Gard Plus. Express clarity as the percentage ratio of the intensity of light with specimen and without specimen in the path of light.

Film Test Method for Dart Drop Impact Resistance: measure according to ASTM D1709-16, Standard Test Methods for Impact Resistance of Plastic Film by the Free-Falling Dart Method.

Film Test Method for Elmendorf Tear Resistance: measure in Cross Direction (CD) and Machine Direction (MD) according to ASTM D1922-15 (2020), Standard Test Method for Propagation Tear Resistance of Plastic Film and Thin Sheeting by Pendulum Method.

Film Test Method for Puncture Resistance: measure according to ASTM D5748-95(2012), Standard Test Method for Protrusion Puncture Resistance of Stretch Wrap Film. Determines the resistance to puncture of a film as resistance to penetration of the film by a probe impinging the film at a standard speed such as 250 millimeters per minute (mm/min.). The probe is coated with a polytetrafluoroethylene and has an outer diameter of 1.905 cm (0.75 inch). The film is clamped during the test. The probe eventually penetrates or breaks the clamped film. The peak force at break, i.e., the maximum force, energy (work) to break or penetrate the clamped film, and the distance that the probe has penetrated at break, are recorded using mechanical testing software. The probe imparts a biaxial stress to the clamped film that is representative of the type of stress encountered by films in many end-use applications. This resistance is a measure of the energy-absorbing ability of a film to resist puncture under these conditions.

Film Test Method for Gloss: measure optical gloss according to ASTM D2457-13, Standard Test Method for Specular Gloss of Plastic Films and Solid Plastics. Measure specular gloss using a glassometer at an incident angle of 45°. Specular gloss is unitless.

Film Test Method for Haze: measure optical haze according to ASTM D1003-13, Standard Test Method for Haze and Luminous Transmittance of Transparent Plastics. Measure haze using a hazemeter. Express haze as percentage of luminous transmission which in passing through the film deviates from an incident beam by forward scattering.

Film Test Method for Hot Tack: measured using an Enepay commercial testing machine according to ASTM F-1921 (Method B). Prior to testing the samples are conditioned for a minimum of 40 hours at 23° C. and 50% relative humidity (R.H.). The hot tack test simulates the filling of material into a pouch or bag before the seal has had a chance to cool completely. Sheets of dimensions 8.5″ by 14″ are cut from the film, with the longest dimension in the machine direction. Strips 1″ wide and 14″ long are cut from the film [samples need only be of sufficient length for clamping]. Tests are performed on these samples over a range of temperatures and the results reported as the maximum load as a function of temperature. Typical temperature steps are 10° C. with 6 replicates performed at each temperature. The typical parameters used in the test are as follows: Specimen Width: 25.4 millimeters (mm, 1.0 inch); Sealing Pressure: 0.275 Newton per square millimeter (N/mm²); Sealing Dwell Time: 1.0 second (sec); Peel speed: 200 millimeters per second (mm/sec); Seal depth=12.7 mm (0.5 inch). Report data as a hot tack curve where Average Hot Tack Force in Newtons (N) is plotted as a function of temperature.

Film Test Method for 1% Secant Modulus: measure in Cross Direction (CD) and Machine Direction (MD) according to ASTM D882-12, Standard Test Methods for Tensile Properties of Thin Plastic Sheeting. Used 1% secant modulus in cross direction (CD) or machine direction (MD). Report results in megapascals (MPa). 1,000.0 pounds per square inch (psi)=6.8948 MPa.

Film Test Method for Zebedee Clarity: measure optical Zebedee clarity according to ASTM D1746-15, Standard Test Method for Transparency of Plastic Sheeting. Measure clarity using a Zebedee CL-100 Meter. Express Zebedee clarity as the percentage ratio of the intensity of light with specimen and without specimen in the path of light.

### Examples

Synthesis of an example of the inventive EtOH-modified spray-dried Ziegler-Natta catalyst system comprising a modifier compound that is a combination of tetrahydrofuran and ethanol, 1:1 (wt/wt): See WO 2019/112929 A1. Add anhydrous ethanol (14 kilograms (kg)) and anhydrous tetrahydrofuran (14 kg) to a feed tank. Next add finely-divided solid MgCl₂ (1255 g). Heat mixture to 60° C., and mix it for 5 hours to overnight to form a third solution. Cool third solution to 40° C. to 45° C. Then add TiCl₃.AA (459 g), and mix for 1 hour. “TiCl₃.AA” is available from W. R. Grace and means a mixture of a 3:1 molar ratio of TiCl₃/AlCl₃, which may be obtained from a commercial supplier or may be made by a reaction of 3 mole equivalents of TiCl₄ with one mole equivalent of aluminum (Al) metal (Al⁰), which acts as a reducing agent, in a solvent, such as anhydrous tetrahydrofuran. Then add hydrophobic pre-treated fumed silica (Cabosil TS-610, 1.6 kg) to give a suspension. Mix the suspension for 30 minutes to give a slurry of a modified Ziegler-Natta procatalyst system and hydrophobic pre-treated fumed silica. The slurry has a blue color. Spray the slurry in a spray dryer using the following conditions: inlet temperature 160° C., outlet temperature 110° C., feed rate approximately 45 kg per hour, total gas flow approximately 270 kg per hour, atomizer speed: varied typically approximately 85%, to give EtOH-modified spray-dried Ziegler-Natta procatalyst system modified by tetrahydrofuran/ethanol 1:1 (wt/wt). Contact the EtOH-modified spray-dried Ziegler-Natta procatalyst system with a chemically reducing effective amount of a reagent mixture of 40 wt % trihexylaluminum (TnHAl) reducing agent in mineral oil in a 4 liter (L) volume mix tank for approximately 1 hour to give a reaction mixture, then add a reagent mixture of 12 wt % diethylaluminum chloride (DEAC) in mineral oil to the reaction mixture and mix for an additional 1 hour to give the chemically-reduced, modified spray-dried Ziegler-Natta catalyst. The molar ratio of TnHAl to DEAC is approximately 0.875/1.000.

TABLE 1
Polymerization Conditions for making reference
C4-LLDPE A and Inventive C4-LLDPE B.

| | Polymerization Conditions | |
|---|---|---|
| | | Inventive C4- |
| | Reference | LLDPE |
| | C4-LLDPE A | B |
| | Ziegler-Natta Catalyst | |
| | UCAT ™ J | |
| | (modified by | |
| | THF, but not | THF and |
| | by EtOH) | EtOH-modified |
| Bed Temperature (° C.) | 85.6 | 85.6 |
| Production Rate, kilogram polymer per hour [kg/hr] | 4080 | 3174 |
| Bed Weight, kilograms [kg] | 14180 | 14596 |
| Residence Time, hours | 3.5 | 4.6 |
| Reactor Pressure, Pascals [Pa] | 1.68 × 106 | 1.69 × 10\hat{ }6 |
| Superficial Gas Velocity, meter per second [m/s] | 0.539 | 0.542 |
| Ethylene partial pressure, pounds per square inch gauge + 1 | 690900 | 686760 |
| atmosphere [psia] | | |
| Bed Temperature [C] | 85.6 | 85.6 |
| Hydrogen/ethylene molar ratio (H₂/C₂ Ratio), [mol/mol] | 0.156 | 0.139 |
| 1-Butene/ethylene molar ratio (C₄/C₂ Ratio), [mol/mol] | 0.386 | 0.454 |
| Aluminum/Titanium molar ratio (Al/Ti Ratio), [mol/mol] | 38 | 43 |
| Ethylene concentration (C₂), Mol % | 38.89 | 38.43 |
| 1-butene concentration (C₄), Mol % | 14.99 | 17.54 |
| Hydrogen concentration (H₂), Mol % | 6.09 | 5.34 |
| Isopentane concentration, Mol % | 0.12 | 0.06 |
| Nitrogen concentration (N₂), Mol % | 39.98 | 38.24 |
| Production Rate [kg/h] | 4080 | 3174 |

Reference LLDPE A is a linear low-density ethylene/1-butene copolymer made by copolymerizing ethylene and 1-butene using gas phase polymerization conditions listed in Table 1 above and a comparative ethanol-free tetrahydrofuran-modified Ziegler-Natta catalyst that is sold as UCAT™ J by UNIVATION and The Dow Chemical Company. The UCAT™ J catalyst is not made using ethanol and is free of ethanol.

Inventive C4-LLDPE B is a linear low-density ethylene/I-butene copolymer made by copolymerizing ethylene and 1-butene using the spray-dried EtOH-modified Ziegler-Natta catalyst Version 1a, 1b, 2, or 3 and using the gas phase polymerization conditions listed in Table 1 above.

Reference LDPE C is a low-density polyethylene (not LLDPE) that is sold by DOW under product number LDPE 450E, which is made in a catalyst-free, high-pressure polymerization process.

Inventive C6-LLDPE is a linear low-density ethylene/1-hexene copolymer made by copolymerizing ethylene and 1-hexene using XCAT™ EZ-100, a commercial bridged bis(indenyl)zirconocene catalyst, and gas phase conditions. LLDPE D is the EZP-2010 product.

TABLE 2
Features of C4-LLDPE A, C4-LLDPE B, LDPE C, and C6-LLDPE D:

| | Features | | | |
|---|---|---|---|---|
| | Reference | Inventive | | Inventive |
| | C4- | C4- | | C6- |
| | LLDPE A | LLDPE B | LDPE C | LLDPE D |
| | Monomer | | | |
| | ethylene | ethylene | ethylene | ethylene |
| | Comonomer | | | |
| | 1-butene | 1-butene | None | 1-hexene |
| | Catalyst (ZN = Ziegler-Natta) | | | |
| | | | | bridged |
| | | EtOH- | None | bis(indenyl) |
| | EtOH-free | modified | (high | zirconocene |
| | ZN | ZN | press.) | catalyst |
| Density (g/cm³) | 0.919 | 0.918 | 0.923 | 0.920 |
| Melt index (I₂, 190 C., 2.16 kg) | 1.8 | 2.4 | 2.0 | 1.0 |
| Mw/Mn | 4.20 | 4.42 | n.r. | n.r. |
| Mz/Mw | 3.51 | 3.78 | n.r. | n.r. |
| CUMCDI | −0.49 | −0.56 | n.r. | n.r. |
| R2* of CUMCDI | 0.75 | 0.90 | n.r. | n.r. |
| CDBI (%) | 43.5 | 45.6 | n.r. | n.r. |
| α (iCCD at 25.0° to 37.0° C.) (wt %) | 8.6 | 10.9 | n.r. | n.r. |
| β (iCCD at 93.0° to 120.0° C.) (wt %) | 12.1 | 12.2 | n.r. | n.r. |
| γ (CCD at 75.0° to 93.0° C.) (wt %) | 45.2 | 43.1 | n.r. | n.r. |
| δ (iCCD wt % at 93.0° to 120.0° C. divided | 0.267 | 0.284 | n.r. | n.r. |
| by iCCD wt % at 75.0° to 93.0° C.) | | | | |
| Mw fraction ratio (Mw of the fraction | | | | |
| eluting between 93.0° C. to 120.0° C. | 1.960 | 2.207 | n.r. | n.r. |
| divided by Mw of the whole polymer | | | | |
| eluting from 25.0° C. to 120.0° C.) | | | | |

*R² is a coefficient of linear fitting and is calculated using an EXCEL linear regression between the cumulative weight fraction at 0.10 to 0.95;
n.r. means “not reported”.

TABLE 3
Polyolefin compositions for making 7-Layer Films 1 to 4 shown in later Tables.

| | Reference | Inventive | | Inventive |
|---|---|---|---|---|
| | C4-LLDPE | C4-LLDPE | | C6-LLDPE |
| Example | A | B | LDPE C | D |
| Blend 1 - comparative (wt %) | 90 | 0 | 10 | 0 |
| Singleton 2 - comparative (wt %) | 100 | 0 | 0 | 0 |
| Blend 3 - comparative (wt %) | 90 | 0 | 0 | 10 |
| Blend 4 - comparative (wt %) | 0 | 90 | 10 | 0 |
| Singleton 5- comparative (wt %) | 0 | 100 | 0 | 0 |
| Blend 6 - inventive (wt %) | 0 | 90 | 0 | 10 |

TABLE 4
Film Extruder Line Parameters for making 7-
Layer Films 1 to 4 shown in later Tables.

| | |
|---|---|
| Die Size: | 9.84 in (25 cm) |
| Die Gap: | 78.7 mil (2 mm) |
| Blow Up Ratio (BUR): | 2.5 |
| Frost Line Height | 35 in (89 cm) |
| Output Rate: | 310 lbs/hr (141 kg/hr) |

TABLE 5
Alpine 7 Film Extruder Line Head Pressures for making
7-Layer Films 1 to 4 shown in later Tables:

| | Example No.: | | | |
|---|---|---|---|---|
| | | Comp. Ex. | | |
| | Comp. Ex. A | B | Comp. Ex. C | Inv. Ex. 1 |
| | 7-Layer Film No.: | | | |
| | 1 | 2 | 3 | 4 |
| Head Pressure | 28.0 | 27.0 | 24.5 | 26.0 |
| Extruder 1, MPa | | | | |
| Head Pressure | 29.5 | 29.5 | 27.4 | 28.1 |
| Extruder 2, MPa | | | | |
| Head Pressure | 25.0 | 25.5 | 23.3 | 23.2 |
| Extruder 3, MPa | | | | |
| Head Pressure | 23.4 | 23.9 | 22.1 | 22.2 |
| Extruder 4, MPa | | | | |
| Head Pressure | 22.4 | 22.6 | 21.4 | 21.5 |
| Extruder 5, MPa | | | | |
| Head Pressure | 30.2 | 29.9 | 27.8 | 28.0 |
| Extruder 6, MPa | | | | |
| Head Pressure | 28.8 | 28.1 | 26.4 | 25.8 |
| Extruder 7, MPa | | | | |
| Average Pressure | 26.8 | 26.6 | 24.7 | 25.0 |
| 1~7, MPa | | | | |

TABLE 6
Comparative 7-Layer Film 1:

| | Like Layer | | | |
|---|---|---|---|---|
| | Grouping | Layers (referencing | Polyolefin | Thickness |
| Extruder No. | (referencing FIG. 2) | FIG. 2) | Compositions | Ratio (%) |
| Extruder 1 | Like Layer | Outermost Layer 21 | Blend 1 | 16.7 |
| Extruder 2 | Grouping 200 | Outer Layer 22 | Blend 1 | 16.7 |
| Extruder 3 | Like Layer | Core Layer 31 | Singleton 2 | 11.1 |
| Extruder 4 | Grouping 300 | Core Layer 32 | Singleton 2 | 11.1 |
| Extruder 5 | | Core Layer 33 | Singleton 2 | 11.1 |
| Extruder 6 | Like Layer | Outer Layer 41 | Blend 1 | 16.7 |
| Extruder 7 | Grouping 400 | Outermost Layer 42 | Blend 1 | 16.7 |

TABLE 7
Comparative 7-Layer Film 2:

| | Like Layer Grouping | Layers (referencing | Polyolefin | Thickness |
|---|---|---|---|---|
| Extruder No. | (referencing FIG. 2) | FIG. 2) | Compositions | Ratio (%) |
| Extruder 1 | Like Layer Grouping 200 | Outermost Layer 21 | Blend 3 | 16.7 |
| Extruder 2 | | Outer Layer 22 | Blend 3 | 16.7 |
| Extruder 3 | Like Layer Grouping 300 | Core Layer 31 | Singleton 2 | 11.1 |
| Extruder 4 | | Core Layer 32 | Singleton 2 | 11.1 |
| Extruder 5 | | Core Layer 33 | Singleton 2 | 11.1 |
| Extruder 6 | Like Layer Grouping 400 | Outer Layer 41 | Blend 3 | 16.7 |
| Extruder 7 | | Outermost Layer 42 | Blend 3 | 16.7 |

TABLE 8
Comparative 7-Layer Film 3:

| | Like Layer Grouping | Layers (referencing | Polyolefin | Thickness |
|---|---|---|---|---|
| Extruder No. | (referencing FIG. 2) | FIG. 2) | Compositions | Ratio (%) |
| Extruder 1 | Like Layer Grouping 200 | Outermost Layer 21 | Blend 4 | 16.7 |
| Extruder 2 | | Outer Layer 22 | Blend 4 | 16.7 |
| Extruder 3 | Like Layer Grouping 300 | Core Layer 31 | Singleton 5 | 11.1 |
| Extruder 4 | | Core Layer 32 | Singleton 5 | 11.1 |
| Extruder 5 | | Core Layer 33 | Singleton 5 | 11.1 |
| Extruder 6 | Like Layer Grouping 400 | Outer Layer 41 | Blend 4 | 16.7 |
| Extruder 7 | | Outermost Layer 42 | Blend 4 | 16.7 |

TABLE 9
Inventive 7-Layer Film 4:

| | Like Layer Grouping | Layers (referencing | Polyolefin | Thickness |
|---|---|---|---|---|
| Extruder No. | (referencing FIG. 2) | FIG. 2) | Compositions | Ratio (%) |
| Extruder 1 | Like Layer Grouping 200 | Outermost Layer 21 | Blend 6 | 16.7 |
| Extruder 2 | | Outer Layer 22 | Blend 6 | 16.7 |
| Extruder 3 | Like Layer Grouping 300 | Core Layer 31 | Singleton 5 | 11.1 |
| Extruder 4 | | Core Layer 32 | Singleton 5 | 11.1 |
| Extruder 5 | | Core Layer 33 | Singleton 5 | 11.1 |
| Extruder 6 | Like Layer Grouping 400 | Outer Layer 41 | Blend 6 | 16.7 |
| Extruder 7 | | Outermost Layer 42 | Blend 6 | 16.7 |

TABLE 10
Properties of a 7-Layer Films 1 to 4 with a Thickness of 51 μm (2 mils):

| | Example No.: | | | |
|---|---|---|---|---|
| | Comp. Ex. A | Comp. Ex. B | Comp. Ex. C | Inv. Ex. 1 |
| | Type | | | |
| | Comparative | Comparative | Comparative | Inventive |
| | 7-Layer Film No.: | | | |
| | 1 | 2 | 3 | 4 |
| Zebedee Clarity | 65.9 | 47.4 | 54.0 | 49.1 |
| Clarity, %: | 98.7 | 95.8 | 98.1 | 95.5 |
| Haze, % | 15.6 | 22.9 | 18.8 | 23.5 |
| Gloss | 48.0 | 30.4 | 43.5 | 32.2 |
| Secant 1% CD, | 49,429/341 | 50,801/350 | 50,821/350 | 49,366/340 |
| psi/MPa | | | | |
| Secant 1% MD, | 42,171/291 | 40,520/279 | 41,563/287 | 40,007/276 |
| psi/MPa | | | | |
| Puncture, J/m³ | 1.11 × 10⁷ | 1.23E+07 | 9.52E+06 | 1.16E+07 |
| Elmendorf Tear CD, | 392/100 | 363/92 | 377/96 | 383/97 |
| gf/mil/kg/cm: | | | | |
| Elmendorf Tear MD, | 152/39 | 187/48 | 150/38 | 181/46 |
| gf/mil/kg/cm | | | | |
| Dart Impact Total | 0.21 | 0.22 | 0.21 | 0.22 |
| Energy, Joules (J) | | | | |

TABLE 11
Hot Tack of a 7-Layer Films 1 to 4 with a Thickness of 51 μm (2 mils):

| | Example No.: | | | |
|---|---|---|---|---|
| | Comp. Ex. A | Comp. Ex. B | Comp. Ex. C | Inv. Ex. 1 |
| | Type | | | |
| | Comparative | Comparative | Comparative | Inventive |
| | 7-Layer Film No. | | | |
| | 1 | 2 | 3 | 4 |
| Temperature (° C.) | Hot Tack, Newton (N) | Hot Tack (N) | Hot Tack (N) | Hot Tack (N) |
| 80 | 0.3 | 0.3 | 0.3 | 0.5 |
| 90 | 0.3 | 0.3 | 0.3 | 0.6 |
| 100 | 1.0 | 0.8 | 1.1 | 1.6 |
| 110 | 2.0 | 2.2 | 2.1 | 2.1 |
| 120 | 1.8 | 2.1 | 1.8 | 1.9 |

Relative to comparative LLDPE blend of Comp. Ex. A and/or Comp. Ex. B, the inventive LLDPE blend of IE1 has decreased average extruder die pressure during film forming. In addition, relative to comparative film 1 and/or film 2, inventive film 4 yet retains similar film puncture property and has decreased hot tack initiation temperature.

Relative to comparative LLDPE blend Comp. Ex. C, the inventive LLDPE blend IE1 has similar average extruder die pressure and yet relative to comparative film 3, inventive film 4 has increased film puncture property and decreased hot tack initiation temperature.

1. A post-reactor blend of linear low-density polyethylene copolymers (“LLDPE blend”) useful for making films, the LLDPE blend comprising a linear low-density ethylene/1-butene copolymer (“C4-LLDPE”), which has the following properties derived from being made by a spray-dried, ethanol-modified Ziegler-Natta catalyst (sdEtOH/ZN): a density from 0.910 gram per cubic centimeter (g/cm³) to 0.935 g/cm³ and a melt index I₂ (190° C., 2.16 kg) from 0.8 gram per 10 minutes (g/10 min) to 2.8 g/10 min; and a linear low-density ethylene/1-hexene copolymer (“C6-LLDPE”), which has the following properties derived from being made by a bridged bis(indenyl)zirconocene catalyst: a density from 0.915 g/cm³ to 0.925 g/cm³ and a melt index I₂ (190° C., 2.16 kg) from 0.7 gram per 10 minutes (g/10 min) to 1.4 g/10 min.

2. The post-reactor blend as claimed in claim 1 having any one of limitations (i) to (iii):
(i) wherein the C4-LLDPE has at least one, alternatively all but one, alternatively each of the following sdEtOH/ZN catalyst-derived properties: a polydispersity Mw/Mn greater than 4.3; a ratio of Mw of the fraction eluting between 93.0° C. to 120.0° C. divided by the Mw of the whole polymer eluting from 25.0° C. to 120.0° C. greater 2.0, alternatively greater than 2.1; CUMCDI<−0.5, wherein CUMCDI is cumulative molecular weight comonomer distribution index; a polymer fraction eluting from 25° to 37° C. of from 9.0 wt % to 12.0 wt % measured by iCCD; and a polymer fraction eluting from 75° to 93° C. of less than 44.5 wt % measured by iCCD, wherein iCCD is improved method for comonomer content distribution analysis;
(ii) wherein the C6-LLDPE has at least one of the following bridged bis(indenyl)zirconocene catalyst-derived properties: a polydispersity Mw/Mn from 2.5 to 4.0; and a long chain branching (LCB) value from 0.001 long-chain branches per 1000 carbon atoms (LCB/1000C) to 0.094 LCB/1000C; and
(iii) both limitations (i) and (ii).

3. The post-reactor blend as claimed in claim 1 wherein the post-reactor blend is free of a low-density polyethylene, a reference linear low-density polyethylene that is different than the C4-LLDPE and the C6-LLDPE, or a high-density polyethylene; or wherein the post-reactor blend contains a low-density polyethylene, a reference linear low-density polyethylene that is different than the C4-LLDPE and the C6-LLDPE, or a high-density polyethylene.

4. The post-reactor blend as claimed in claim 1 wherein the bridged bis(indenyl)zirconocene catalyst is rac-dimethylsilylene-bis(4,5,6,7-tetrahydro-1-indenyl)zirconium(IV) dichloride.

5. A post-reactor method of making the LLDPE blend as claimed in claim 1, the method comprising: melting solids of the C4-LLDPE to form a melt thereof; melting solids of the C6-LLDPE to form a melt thereof; and mixing the melts together to form the LLDPE blend.

6. The method as claimed in claim 5 comprising, before the melting steps:
making the C4-LLDPE having sdEtOH/ZN catalyst-derived properties by copolymerizing ethylene and 1-butene using a spray-dried, ethanol-modified Ziegler-Natta catalyst (“sdEtOH/ZN”), wherein the spray-dried, ethanol-modified Ziegler-Natta catalyst is prepared from the following materials: a titanium compound that is Ti(O-isopropyl)₄ or TiCl₄ or TiCl₃/AlCl₃; magnesium dichloride (MgCl₂); a hydrophobic fumed silica; a modifier compound comprising ethanol and, optionally, tetrahydrofuran; and an aluminum compound selected from a trialkylaluminum, an alkylaluminum dichloride, a dialkylaluminum chloride, or a combination of any two or more thereof; and
making the C6-LLDPE having the bridged bis(indenyl)zirconocene catalyst-derived properties by copolymerizing ethylene and 1-hexene using a bridged bis(indenyl)zirconocene catalyst,
wherein the bridged bis(indenyl)zirconocene catalyst is selected from the group consisting of: an ethylene bis(2-methyl indenyl)zirconium catalyst, a dimethylsilyl bis(2-methyl indenyl)zirconium catalyst, a diphenylsilyl bis(2-methyl indenyl)zirconium catalyst, a diphenylsilyl bis(2-methyl, 4-phenyl-indenyl)zirconium catalyst, and a diethylsilyl bis(2-methyl, 4-phenyl indenyl)zirconium catalyst; or
wherein the bridged bis(indenyl)zirconocene catalyst is selected from the group consisting of: ethylene bis(4,5,6,7-tetrahydro-1-indenyl)zirconium dichloride, ethylene bis(4,5,6,7-tetrahydro-1-indenyl)zirconium dimethyl, dimethylsilyl bis(4,5,6,7-tetrahydro-1-indenyl)zirconium dichloride, dimethylsilyl bis(4,5,6,7-tetrahydro-1-indenyl)zirconium dimethyl, diphenylsilyl bis(4,5,6,7-tetrahydro-1-indenyl)zirconium dichloride, diphenylsilyl bis(4,5,6,7-tetrahydro-1-indenyl)zirconium dimethyl, diethylsilyl bis(4,5,6,7-tetrahydro-1-indenyl)zirconium dichloride, and diethylsilyl bis(4,5,6,7-tetrahydro-1-indenyl)zirconium dimethyl.

7. The method of claim 6 wherein the bridged bis(indenyl)zirconocene catalyst is rac-dimethylsilylene-bis(4,5,6,7-tetrahydro-1-indenyl)zirconium(IV) dichloride.

8. A film comprising the post-reactor blend as claimed in claim 1.

9. The film of as claimed in claim 8 wherein the film is a monolayer film consisting of one layer and wherein the one layer comprises the post-reactor blend as claimed in claim 1; or wherein the film is a multilayer film consisting of 3 to 12 layers wherein at least one of the 3 to 12 layers comprises the post-reactor blend as claimed in claim 1.

10. The film as claimed in claim 8 wherein the film is a multilayer film consisting of 3 to 12 layers comprising 2 to 4 outer layers and 1 to 8 core layers; wherein at least one outer layer independently comprises from 70 to 98 wt % of the C4-LLDPE and from 30 to 2 wt % of the C6-LLDPE, all based on the total weight of the C4-LLDPE+C6-LLDPE in the at least one outer layer; an wherein at least one core layer independently comprises from 80 to 100 wt % of the C4-LLDPE and from 20 to 0 wt % of the C6-LLDPE, all based on the total weight of the C4-LLDPE+C6-LLDPE in the at least one core layer.

11. A method of making the multilayer film as claimed in claim 10, the method comprising extruding through different ones of from 3 to 12 dies at least one melt of the LLDPE blend, and optionally through a different one of the dies a melt of the C4-LLDPE, thereby making the multilayer film consisting of 3 to 12 layers.
